(19) United States
(12) Patent Application Publication
(10) Pub. No.: US 2005/0162066 A1
(43) Pub. Date: Jul. 28, 2005

(54) Field emission type backlight unit for LCD apparatus

(76) Inventor: Nam-sin Park, Suwon-si (KR)

Correspondence Address: MCGUIREWOODS, LLP, 1750 TYSONS BLVD, SUITE 1800, MCLEAN, VA, 22102, US

(21) Appl. No.: 11/041,931

(22) Filed: Jan. 26, 2005

(30) Foreign Application Priority Data
Jan. 28, 2004 (KR) 10-2004-0005304

(51) Int. Cl. H01J 1/62; H01J 63/04

(52) U.S. Cl. 313/495

(57) ABSTRACT

A field emission type back light unit for a liquid crystal display may includes a front substrate and a rear substrate that are spaced and facing each other, an anode electrode on a lower surface of the front substrate, a fluorescent layer in a light emitting area, and a getter layer adjacent to the fluorescent layer within the light emitting area. The fluorescent and getter layer may be formed in predetermined patterns on the surface of the anode electrode. The back light unit may also include first and second cathode electrodes in patterns corresponding to the fluorescent and getter layers on an upper surface of the rear substrate, a first emitter on the first cathode electrode to emit electrons to excite the fluorescent layer, and a second emitter on the second cathode electrode to emit electrons to activate the getter layer.

### BACKGROUND OF THE INVENTION

This application claims the priority of Korean Patent Application No. 2004-5304, filed on Jan. 28, 2004, which is incorporated herein in its entirety by reference.

(a) Field of the Invention

The present invention relates to a back light unit for a liquid crystal display (LCD), and particularly to a field emission type back light unit capable of continuously maintaining a high degree of vacuum by forming non-evaporable getter layer at a front substrate.

(b) Description of the Related Art

In general, flat panel displays can be classified as either light emitting displays or light receiving displays. Examples of the light emitting displays include a cathode ray tube (CRT), a plasma display panel (PDP), and a field emission display (FED). Examples of the light receiving displays include a liquid crystal display (LCD). The LCD apparatus has the advantages of light weight and low power consumption. However, an LCD has disadvantages in that an image is not observed in a dark place because it is a light receiving display apparatus. Thus the image is produced not by self-emitting but by external light. To overcome this disadvantage, the LCD display can include a backlight device at a rear side of the LCD apparatus.

As a conventional backlight device, a cold cathode fluorescent lamp (CCFL) has been commonly used as a linear light source, and a light emitting diode (LED) as a point light source. However, such a conventional backlight device has disadvantages in that its production cost is high because it is structurally complex and consumes high power in reflecting and transmitting light because a light source is located on a side. In particular, it is difficult to obtain a uniform brightness in larger size LCDs.

Recently, a field emission type backlight device with a planar light emitting structure has been proposed to solve the above-mentioned problems. Such a field emission type backlight device has low power consumption and a relatively uniform brightness even in a wide light emitting region compared to a backlight device using a conventional cold cathode fluorescent lamp or the like.

FIG. 1 is a cross section view showing a conventional field emission type back light unit, and FIG. 2 is a schematic plan view of the conventional field emission type back light unit shown in FIG. 1.

The conventional field emission type back light unit has a front substrate 10 and a rear substrate 20 that are separated from each other by a predetermined gap. An anode electrode 11 is provided on a lower surface of the front substrate 10. A cathode electrode 21 is provided on an upper surface of the rear substrate 20.

The anode electrode 11 and the cathode electrode 21 are generally made of Indium Tin Oxide (ITO), which is a transparent conductive material. Because ITO has a relatively high line resistance, a thin film metal layer 22 is generally formed on the upper surface of the cathode electrode 21 in order to reduce line resistance of the cathode electrode 21 made of ITO. On the upper surface of the thin film metal layer 22, an emitter 23 made of carbon nanotube (CNT) is formed in a predetermined pattern. A fluorescent layer 12 having a pattern corresponding to the emitter 23 is formed on the surface of the anode electrode 11 formed on the front substrate 10.

The front and rear substrates 10 and 20 are separated by using a plurality of spacers 31 for maintaining space between substrates 10 and 20, and sealed with a frit glass 32 that is arranged along edges of the substrates 10 and 20.

In the back light unit, if a voltage is applied between the cathode electrode 21 and the anode electrode 11, electrons are emitted from the emitter 23. The emitted electrons collide on the fluorescent layer 12. Fluorescent materials in the fluorescent layer 12 are excited, so that visible light emits.

On the other hand, it is necessary to maintain the space between the front and rear substrates 10 and 20 in high vacuum, so that electrons can move without losing energy. For this reason, an exhaust pipe 33 for exhausting gas from the space between the front and rear substrates 10 and 20 is provided at the outside of a light emitting area 40 of the rear substrate 20. In addition, in order to increase a degree of vacuum within the back light unit, a getter chamber 34 having a getter 35 is provided at the outside of the light emitting area 40 of the rear substrate 20. The getter 35 functions to adsorb residual gas in the space between the front and rear substrates 10 and 20. The getter 35 has a shape of strip or pellet. The getter is formed by coating a non-evaporable getter material on a metallic surface.

The distance between the front substrate 10 and rear substrate 20 is very narrow, for example about 200 μm to about 2 mm. In addition, the conventional getter 35 is arranged on a corner of the rear substrate 20. Therefore, flow resistance of gas moving to the getter 35 becomes large. As a result, the getter 35 does not effectively adsorb gas. Accordingly, in the prior art, it takes over 10 hours to perform a heating exhaust to ensure an initial degree of vacuum.

In a conventional back light unit, when the emitter 23 emits electrons, various gases are continuously generated from various materials within the back light unit. Therefore, the degree of vacuum gradually decreases as time passes. As described above, if the residual gas increases in the narrow space between the front and rear substrates 10 and 20, the residual gas is ionized by a high voltage applied between the front and rear substrates 10 and 20. The residual gas causes arc discharge. This discharge can destroy the electrodes 11 and 21 and the fluorescent layer 12 in the back light unit. This may shorten the life time of the back light unit.

In addition, the conventional getter chamber 34 containing the getter 35 for adsorbing gas protrudes beyond the rear substrate 20, so the whole thickness of the back light unit increases.

### SUMMARY OF THE INVENTION

The present invention provides a field emission type back light unit that may be capable of continuously maintaining a high degree of vacuum by providing a non-evaporable getter layer at a front substrate.

According to an aspect of the present invention, a field emission type back light unit may include a front substrate and a rear substrate that are separated and face each other, an anode electrode on a lower surface of the front substrate, a fluorescent layer in an area for emitting light, and a getter layer adjacent to the fluorescent layer within at least the area for emitting light. The fluorescent and getter layer may be formed in predetermined patterns on the surface of the anode electrode. It may also include first and second cathode electrodes that are formed in patterns corresponding to the fluorescent and getter layers on a upper surface of the rear substrate, a first emitter on the first cathode electrode to emit electrons to excite the fluorescent layer, and a second emitter on the second cathode electrode to emit electrons to activate the getter layer.

The fluorescent layer may be formed in a plurality of lines, and the getter layer may have line-shaped portions in parallel to the fluorescent layer. The fluorescent layer and the getter layer may be alternately arranged by one line.

The getter layer may further include a portion for surrounding the light emitting area. The anode electrode may be a surface-type electrode formed on the lower surface of the front substrate. The anode electrode may have first and second anode electrodes formed in patterns corresponding to the fluorescent and getter layers, the fluorescent layer may be formed on the surface of the first anode electrode, and the getter layer may be formed on the surface of the second anode electrode.

The anode electrode, the first cathode electrode, and the second cathode electrode may be made of ITO. A thin film metal layer may be formed on upper surfaces of the first and second cathode electrodes.

Further, a resistive layer may be formed between the first cathode electrode and the first emitter and between the second cathode electrode and the second emitter. The resistive layer may be made of carbon paste.

The first and second emitters may be made of carbon nanotube. The getter layer may be made of a non-evaporable getter material. The non-evaporable getter material may include zirconium.

The getter layer may be formed by a screen print method using a paste-state getter material or by electrophoresis. The paste may be formed by mixing a binder solution including nitrocellulose and acetate with zirconium powder. The paste may contain the zirconium powder of about 60 to about 90 wt %.

### BRIEF DESCRIPTION OF THE DRAWINGS

FIG. 1 is a cross section view showing one example of a conventional field emission type back light unit.

FIG. 2 is a schematic plan view of the conventional back light unit shown in FIG. 1.

FIG. 3 is a cross section view showing a structure of a field emission type back light unit according to a first embodiment of the present invention.

FIG. 4a is a schematic plan view showing an arrangement of an anode electrode, a fluorescent layer, and a getter layer provided on a lower surface of a front substrate shown in FIG. 3.

FIG. 4b is a schematic plan view showing an arrangement of a first and a second cathode electrodes provided on upper surface of a rear substrate shown in FIG. 3.

FIG. 5 is a schematic plan view showing an alternative arrangement of a getter layer rather than that in FIG. 4a.

FIG. 6 is a cross section view showing a structure of a field emission type back light unit according to a second embodiment of the present invention.

FIG. 7 is a schematic plan view showing an arrangement of an anode electrode, a fluorescent layer, and a getter layer provided on a lower surface of a front substrate shown in FIG. 6.

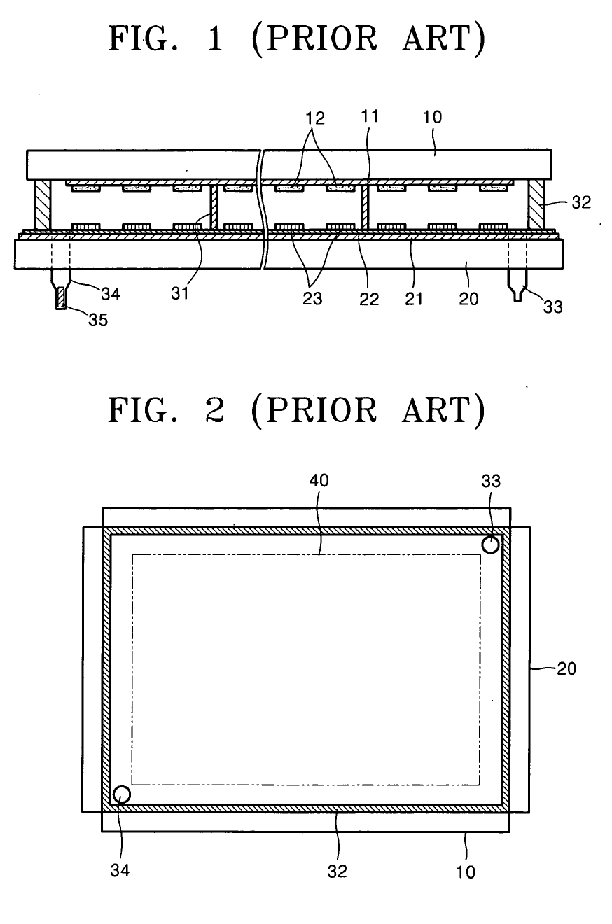

### DETAILED DESCRIPTION OF THE INVENTION

Hereinafter, exemplary embodiments of a field emission type back light unit according to the present invention will be described with reference to the attached drawings. The same elements in the various drawings are indicated by the same reference numerals.

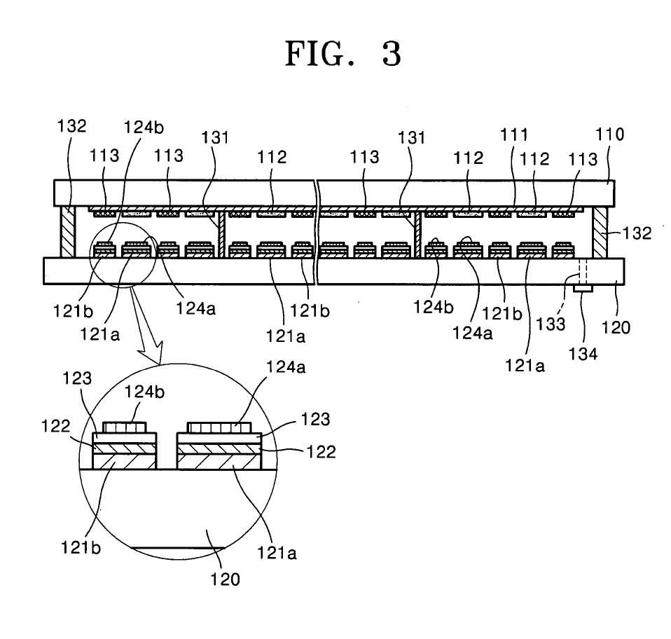

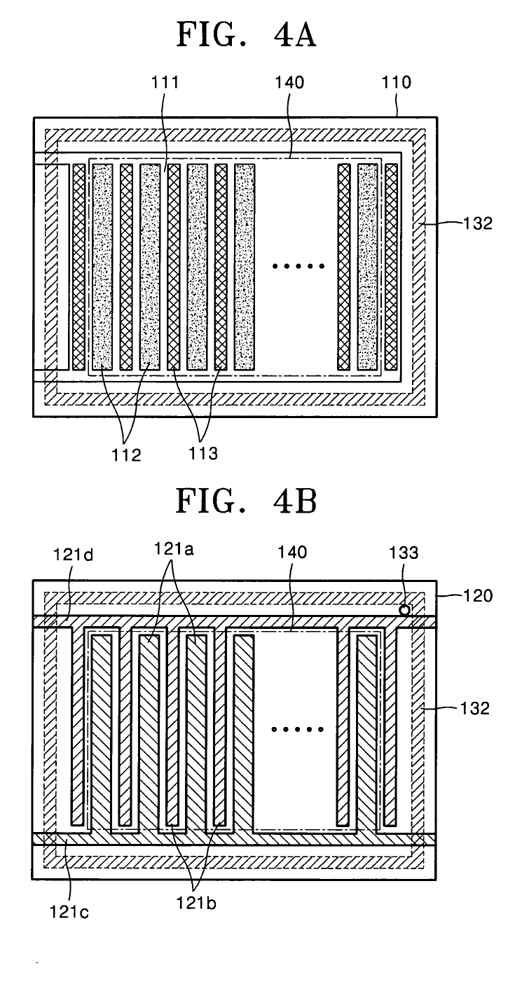

As shown in FIGS. 3, 4a and 4b, a field emission type back light unit according to the present invention may include front and rear substrates 110 and 120 separated and facing each other. The front and rear substrates 110 and 120 may be separated with a plurality of spacers 131 for maintaining space between the front and rear substrates 110 and 120. The front and rear substrates 110 and 120 may be sealed with frit glass 132 disposed along the edge of the substrates. Further, a light emitting area 140 (an area that emits light) may be provided in the front and rear substrates 110 and 120.

The front and rear substrates 110 and 120 can be made of a transparent substrate such as a glass substrate. A unit for emitting electrons may be provided in the rear substrate 120. A unit for emitting light by using the emitted electrons, and a unit for adsorbing gas within the back light unit may be provided on the front substrate 110.

More specifically, an anode electrode 111 may be provided on a lower surface of the front substrate 110. A fluorescent layer 112 for emitting light and a getter layer 113 for adsorbing gas may be provided on the surface of the anode electrode 111. Further, the first and second cathode electrodes 121a and 121b may be provided on the upper surface of the rear substrate 120. The first and second emitters 124a and 124b may function as electron emitting sources formed on the first and second cathode electrodes 121a and 121b, respectively.

The anode electrode 111 can be provided on the lower surface of the front substrate 110 in a surface-type electrode form. This anode electrode 111 can be made of a transparent conductive material, for example, ITO, or indium-zinc-oxide (IZO). Thus light can pass through the anode electrode 111.

The fluorescent layer 112 may be located in a predetermined pattern on a lower surface of the anode electrode 111. The fluorescent layer 112 may be made of R, G, and B fluorescent materials. Preferably, the fluorescent layer 112 may be formed in a plurality of parallel lines in the light emitting area 140. Each of the R, G, and B fluorescent materials may form each of the lines of the fluorescent layer 112. Alternatively, the R, G, and B fluorescent materials may be mixed and then form each of the lines of the fluorescent layer 112.

The getter layer 113 may be formed in a predetermined pattern on the lower surface of the anode electrode 111. Further, the getter layer 113 may be adjacent to the fluorescent layer 112 within at least the light emitting area 140. More particularly, the getter layer 113 may be arranged in the form of a plurality of lines. The getter layer 113 may be parallel to the fluorescent layer 112. The fluorescent layer 112 and the getter layer 113 may be arranged in alternating lines. The getter layer 113 may enhance the adsorption efficiency of gas, described in detail later.

The getter layer 113 may be made of a non-evaporable getter material including, for example, zirconium. A protective film formed on the surface of the getter material may be removed by heating or electron collision, and then the getter material may be activated. As a result, the non-evaporable getter material adsorbs gas. The getter layer 113 may be activated by electrons emitted from the second emitter 124b.

The getter layer 113 can be formed by a screen print method using a paste-state getter material. In particular, zirconium paste may be formed by mixing binder solution including nitrocellulose and butyl karbitol acetate with a high purity of zirconium powder. The zirconium paste may contain zirconium powder of about 60 to about 90 wt %. Next, the zirconium paste may be coated on the surface of the anode electrode 111 by a screen print method. If the coated zirconium paste is baked at about 380 to about 430° C., organic materials in the paste may be dissolved and removed. As a result, only the getter layer 113 made of zirconium powder may remain on the surface of the anode electrode 111. It may be desirable that the getter layer 113 is about 5 to about 50 μm thick.

Alternatively, the getter layer 113 can be formed by electrophoresis. Even in this case, the getter layer 113 may be about 5 to about 50 μm thick.

The first and second cathode electrodes 121a and 121b may be formed to correspond to the fluorescent layer 112 and the getter layer 113 on an upper surface of the rear substrate 120, respectively. That is, the first cathode electrode 121a can be formed as a plurality of parallel lines corresponding to the fluorescent layer 112. The second cathode electrode 121b can be formed as a plurality of parallel lines corresponding to the getter layer 113. Further, the first and second cathode electrodes 121a and 121b can be alternately arranged line by line, similar to the fluorescent layer 112 and the getter layer 113. The first and second cathode electrodes 121a and 121b may be connected to first and second wirings 121c and 121d respectively. Such a connection may be for applying voltage. The first and the second wirings 121c and 121d can be made of ITO or IZO, similar to the first and the second cathode electrodes 121a and 121b.

Further, the first and second cathode electrodes 121a and 121b can be made of ITO, IZO, or another transparent conductive material. ITO and IZO have a relatively high line resistance. Therefore, (in order, for example, to construct a large area of back light unit), a thin film metal layer 122 for reducing the line resistance may be formed as a bus electrode on upper surface of the first and second cathode electrodes 121a and 121b. The thin film metal layer 122 can be made of, for example, chrome (Cr).

The first emitter 124a formed on the first cathode electrode 121a may emit electrons to excite the fluorescent layer 112. The second emitter 124b formed on the second cathode electrode 121b may emit electrons to activate the getter layer 113. The first emitter 124a and second emitter 124b may be made of carbon nanotube (CNT) capable of effectively emitting electrons even with a relatively low driving voltage.

A resistive layer 123 can be formed between the first cathode electrode 121a and the first emitter 124a and between the second cathode electrode 121b and the second emitter 124b. The resistive layer 123 can be made of carbon paste in order to uniformly emit electrons from the first and the second emitter 124a and 124b.

The front and rear substrates 110 and 120 may be separated from each other by predetermined gap. The front and rear substrates 110 and 120 may be sealed by frit glass 132 disposed along the edge of the substrates. Further, heat may be exhausted by including a heating exhaust device (not shown) connected to a vacuum vent 133 formed in a corner of the rear substrate 120, so that a high degree of vacuum within the back light unit can be obtained. After a vacuum of about 10⁻⁵ torr or below is obtained within the back light unit, a voltage may be applied to the second cathode electrode 121b and the anode electrode 111. As a result, electrons can emit from the second emitter 124b, and the getter layer 113 can be activated. Therefore, residual gas may be adsorbed by the getter layer 113, and a higher vacuum can be obtained within the back light unit. If the getter layer 113 is formed over a wide area of a light emitting area 140, the residual gas can be quickly and effectively adsorbed. It can take as little as about 2 hours to perform a heating exhaust process. Therefore, exhausting time of the present invention may be much shorter than the prior art, and it is possible to remarkably reduce costs.

Next, an end portion of a vacuum vent 133 may be fused by a heat melting method. Alternatively, the vacuum vent 133 may be welded with a sealing cap 134. Therefore, high vacuum within the back light unit can be maintained.

On the other hand, adsorption of residual gas by the getter layer 113 can be performed after the vacuum vent 133 is sealed.

In a field emission type back light unit according to a first embodiment of the present invention, a voltage may be applied between the first cathode electrode 121a and the anode electrode 111 to generate electric field between the electrodes 121a and 111. As a result, the first emitter 124a on the first cathode electrode 121a may emit electrons. Electrons emitted from the first emitter 124a may become an electron beam and collide on the fluorescent layer 112. Accordingly, R, G, and/or B fluorescent materials of the fluorescent layer 112 may be excited to emit a visible light.

As described above, since various gases are generated at the time of emitting electrons from the emitter 23 and various gases are continuously generated from various materials within the back light unit, the degree of vacuum may gradually decrease as time passes. When a voltage is applied between the second cathode electrode 121b and the anode electrode 111, the getter layer 113 may again be activated, and the second emitters 124b may emit electrons. The generated gases may be adsorbed by the getter layer 113. As a result, high vacuum can be maintained within the back light unit.

As described above, since the residual gas within the back light unit can be periodically adsorbed by the getter layer 113, high vacuum can be continuously maintained. Therefore, it may be possible to extend life span of the back light unit from about 20,000 to about 50,000 hours. In addition, since the non-evaporable getter layer 113 may be provided on the front substrate 110, an additional getter chamber may not be needed. Therefore, it may be possible to obtain a thin back light unit.

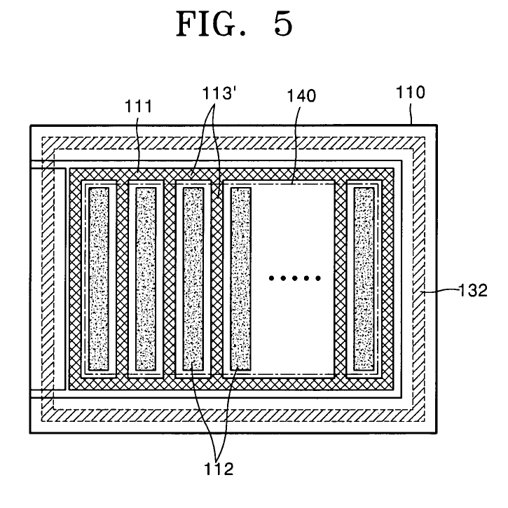

As shown in FIG. 5, a getter layer 113′ formed on the surface of the anode electrode 111 can be formed outside as well as inside the light emitting area 140. That is, the getter layer 113′ may have line-shaped portions in parallel to the fluorescent layer 112 in the light emitting area 140 and a portion for surrounding the light emitting area 140.

Accordingly, the area of the getter layer 113′ may be widened. Therefore, it may be possible to more efficiently adsorb gases.

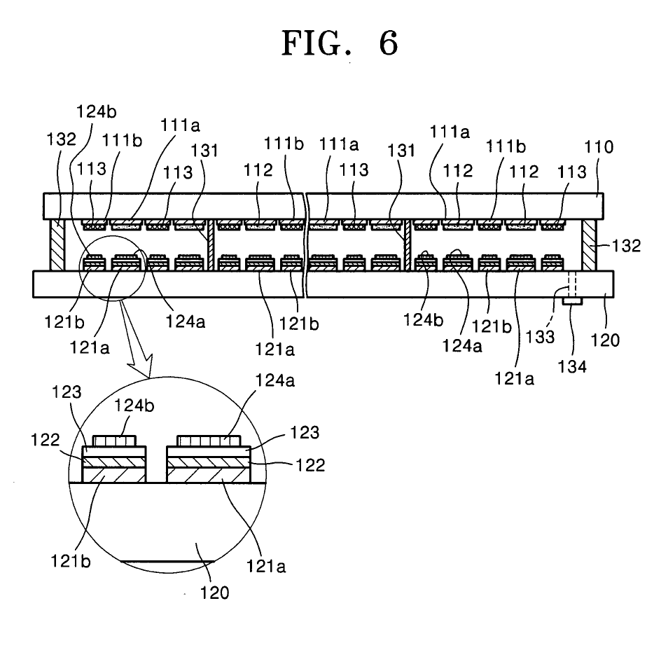

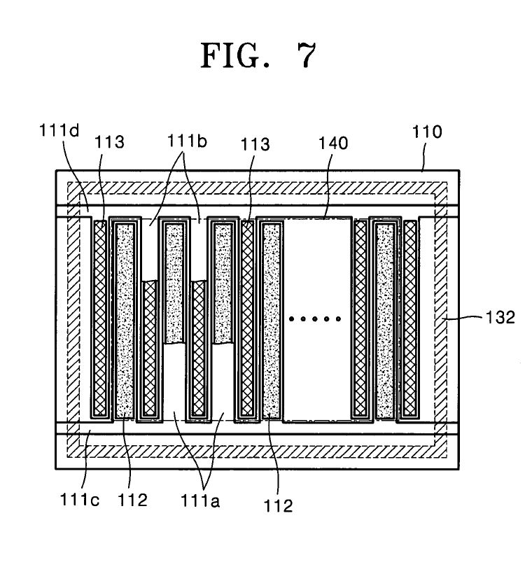

As shown in FIGS. 6 and 7, the back light unit according to the second embodiment of the present invention may include front and rear substrates 110 and 120 separated from each other by spacers 131. The front and rear substrates 110 and 120 may be sealed with frit glass 132 disposed along the edge of the substrates.

The first and second cathode electrodes 121a and 121b may be formed on the rear substrate 120. The first and second emitter 124a and 124b may be electron emission sources on the first and second cathode electrodes 121a and 121b, respectively. Further, a thin film metal layer 122 and a resistive layer 123 can be formed on the first and second cathode electrodes 121a and 121b. Components formed on the rear substrate 120 may, for example, be the same as those mentioned with regard to the first embodiment above.

The first and second anode electrodes 111a and 111b made of, for example, ITO or IZO may be provided on a lower surface of the front substrate 110. The fluorescent layer 112 made of R, G, and B fluorescent materials may be formed on the surface of the first anode electrode 11a. The getter layer 113 made of a non-evaporable getter material may be formed on the surface of the second anode electrode 111b.

The first and second anode electrodes 111a and 111b may be formed in patterns corresponding to the fluorescent layer 112 and the getter layer 113, respectively. That is, the first anode electrode 111a may be formed in parallel lines corresponding to the fluorescent layer 112. The second anode electrode 111b can be formed in parallel lines corresponding to the getter layer 113. Further, the first and second anode electrodes 111a and 111b may be alternately arranged line by line, similar to the arrangement of the fluorescent layer 112 and the getter layer 113. The first and second anode electrodes 111a and 111b may be connected to first and second wirings 111c and 111d for applying voltage. The first and second wirings 111c and 111d can be made of ITO or IZO together with the first and second anode electrodes 111a and 111b.

As described above, the back light unit according to the second embodiment of the present invention can include the first anode electrode 111a for the fluorescent layer 112 and the second anode electrode 111b for the getter layer 113 provided separately on a lower surface of the front substrate 110. In such a construction, the fluorescent layer 112 may be excited by applying voltage between the first cathode electrode 121a and the first anode electrode 111a, and the getter layer 113 may be activated by applying voltage between the second cathode electrode 121b and the second anode electrode 111b. Further, according to the second embodiment, since the first and second anode electrodes 111a and 111b are formed in lines, uniform current can flow in the first and second anode electrodes 111a and 111b. Therefore, brightness can be more uniform over the whole light emitting area 140.

As explained above, since a non-evaporable getter layer may be formed on the front substrate and a CNT emitter for activating the non-evaporable getter layer may be formed on the rear substrate, the back light unit can periodically adsorb residual gas within the back light unit. If necessary, high vacuum can continuously be maintained within the back light unit, and it may be possible to extend life time of the back light unit

Further, since the non-evaporable getter layer is formed on a wide area in the front substrate, it may take less time to perform a heating exhaust process than in the prior art. Therefore, exhausting time of the present invention may be much shorter than the prior art, and it may be possible to remarkably reduce costs.

Furthermore, since a non-evaporable getter layer may be provided on the front substrate, an additional getter chamber may not be needed. Therefore, it may be possible to obtain a thin back light unit.

Although the present invention has been particularly shown and described with reference to exemplary embodiments, various changes in form and details may be made therein without departing from the scope of the invention. The exemplary embodiments should be considered as descriptive not for purposes of limitation.

1. A field emission type back light unit, comprising:
a front substrate and a rear substrate separated and facing each other;
an anode electrode on a lower surface of the front substrate;
a fluorescent layer on a light emitting area defined as an area for emitting light;
a getter layer adjacent to the fluorescent layer within at least the light emitting area,
wherein the fluorescent layer and the getter layer are formed in predetermined patterns on the surface of the anode electrode;
first and second cathode electrodes formed in patterns corresponding to the fluorescent and getter layers on an upper surface of the rear substrate;
a first emitter on the first cathode electrode capable of emitting electrons to excite the fluorescent layer; and
a second emitter on the second cathode electrode capable of emitting electrons to activate the getter layer.

2. The field emission type back light unit of claim 1, wherein the fluorescent layer comprises a plurality of lines, and wherein the getter layer comprises line-shaped portions parallel to the fluorescent layer.

3. The field emission type back light unit of claim 2, wherein the fluorescent layer and the getter layer are arranged alternately.

4. The field emission type back light unit of claim 2, wherein the getter layer further comprises a portion for surrounding the light emitting area.

5. The field emission type back light unit of claim 1, wherein the anode electrode is a surface-type electrode formed on the lower surface of the front substrate.

6. The field emission type back light unit of claim 1, wherein the anode electrode has a first anode electrode and a second anode electrode that are formed in patterns corresponding to the fluorescent and getter layers, wherein the fluorescent layer is provided on a surface of the first anode electrode, and wherein the getter layer is formed on a surface of the second anode electrode.

7. The field emission type back light unit of claim 1, wherein the anode electrode, the first cathode electrode, and the second cathode electrode comprise Indium Tin Oxide (ITO) or Indium Zinc Oxide (IZO).

8. The field emission type back light unit of claim 7, further comprising a thin film metal layer on upper surfaces of the first and second cathode electrodes.

9. The field emission type back light unit of claim 8, wherein the thin film metal layer comprises chrome.

10. The field emission type back light unit of claim 1, further comprising a resistive layer between the first cathode electrode and the first emitter and between the second cathode electrode and the second emitter.

11. The field emission type back light unit of claim 10, wherein the resistive layer comprises carbon paste.

12. The field emission type back light unit of claim 1, wherein the first emitter and the second emitter comprise carbon nanotubes.

13. The field emission type back light unit of claim 1, wherein the getter layer comprises non-evaporable getter material.

14. The field emission type back light unit of claim 13, wherein the non-evaporable getter material comprises zirconium.

15. The field emission type back light unit of claim 13, wherein the getter layer is screen printed using a paste-state getter material.

16. The field emission type back light unit of claim 13, wherein the getter layer is formed by electrophoresis.

17. The field emission type back light unit of claim 13, wherein the getter layer is about 5 to about 50 μm thick.

18. The field emission type back light unit of claim 15, wherein the paste comprises a mix of a binder solution comprising nitrocellulose and acetate with zirconium powder.

19. The field emission type back light unit of claim 18, wherein the paste comprises zirconium powder of about 60 to about 90 weight percentage.
